(19) United States
(12) Patent Application Publication
(10) Pub. No.: US 2005/0256740 A1
(43) Pub. Date: Nov. 17, 2005

(54) Data record matching algorithms for longitudinal patient level databases

(76) Inventors: Mark E. Kohan, Downingtown, PA (US); Clinton J. Wolfe, Malvern, PA (US); Heather Zuleba, Lafayette Hill, PA (US)

Correspondence Address: BAKER & BOTTS, 30 ROCKEFELLER PLAZA, NEW YORK, NY, 10112, US

(21) Appl. No.: 11/122,564

(22) Filed: May 5, 2005

Related U.S. Application Data
(60) Provisional application No. 60/568,455, filed on May 5, 2004.
(60) Provisional application No. 60/572,161, filed on May 17, 2004.
(60) Provisional application No. 60/571,962, filed on May 17, 2004.
(60) Provisional application No. 60/572,064, filed on May 17, 2004.
(60) Provisional application No. 60/572,264, filed on May 17, 2004.

(51) Int. Cl. G06F 17/60

(52) U.S. Cl. 705/2

(57) ABSTRACT

A method is provided for assigning longitudinal linking tags to de-identified patient data records by matching the patient data records with reference data records. The de-identified patient data records may include both encrypted and non-encrypted data attributes. Different possible subsets of the data attributes are categorized in a hierarchy of levels. Subsets of data field values are compared with the reference data records one level at a time. Upon successful comparison or matching of a subset of data field values, a longitudinal linking tag associated with a matched reference data record is assigned to de-identified data record is assigned. When a match is not found, a new longitudinal linking tag is created and assigned to the de-identified data record. The new tag and corresponding data record attributes are then added to the reference data for future matching operations.

### CROSS REFERENCE TO RELATED APPLICATIONS

This application claims the benefit of U.S. provisional patent application Ser. No. 60/568,455 filed May 5, 2004, U.S. provisional patent application Ser. No. 60/572,161 filed May 17, 2004, U.S. provisional patent application Ser. No. 60/571,962 filed May 17, 2004, U.S. provisional patent application Ser. No. 60/572,064 filed May 17, 2004, and U.S. provisional patent application Ser. No. 60/572,264 filed May 17, 2004, all of which applications are hereby incorporated by reference in their entireties herein.

### BACKGROUND OF THE INVENTION

The present invention relates to the management of personal health information or data on individuals. The invention in particular relates to the assembly and use of such data in a longitudinal database in manner, which maintains individual privacy.

Electronic databases of patient health records are useful for both commercial and non-commercial purposes. Longitudinal (life time) patient record databases are used, for example, in epidemiological or other population-based research studies for analysis of time-trends, causality, or incidence of health events in a population. The patient records assembled in a longitudinal database are likely to be collected from a multiple number of sources and in a variety of formats. An obvious source of patient health records is the modern health insurance industry, which relies extensively on electronically-communicated patient transaction records for administering insurance payments to medical service providers. The medical service providers (e.g., pharmacies, hospitals or clinics) or their agents (e.g., data clearing houses, processors or vendors) supply individually identified patient transaction records to the insurance industry for compensation. The patient transaction records, in addition to personal information data fields or attributes, may contain other information concerning, for example, diagnosis, prescriptions, treatment or outcome. Such information acquired from multiple sources can be valuable for longitudinal studies. However, to preserve individual privacy, it is important that the patient records integrated to a longitudinal database facility are “anonymized” or “de-identified”.

A data supplier or source can remove or encrypt personal information data fields or attributes (e.g., name, social security number, home address, zip code, etc.) in a patient transaction record before transmission to preserve patient privacy. The encryption or standardization of certain personal information data fields to preserve patient privacy is now mandated by statute and government regulation. Concern for the civil rights of individuals has led to government regulation of the collection and use of personal health data for electronic transactions. For example, regulations issued under the Health Insurance Portability and Accountability Act of 1996 (HIPAA), involve elaborate rules to safeguard the security and confidentiality of personal health information. The HIPAA regulations cover entities such as health plans, health care clearinghouses, and those health care providers who conduct certain financial and administrative transactions (e.g., enrollment, billing and eligibility verification) electronically. (See e.g., http://www.hhs.gov/ocr/hipaa). Commonly invented and co-assigned patent application Ser. No. 10/892,021, “Data Privacy Management Systems and Methods”, filed Jul. 15, 2004 (Attorney Docket No. AP35879), which is hereby incorporated by reference in its entirety herein, describes systems and methods of collecting and using personal health information in standardized format to comply with government mandated HIPAA regulations or other sets of privacy rules.

For further minimization of the risk of breach of patient privacy, it may be desirable to strip or remove all patient identification information from patient records that are used to construct a longitudinal database. However, stripping data records of patient identification information to completely “anonymize” them can be incompatible with the construction of the longitudinal database in which the stored data records or fields must be updated individual patient-by-patient.

Consideration is now being given to integrating “anonymized” or “de-identified” patient records from diverse data sources in a longitudinal database, where the data sources may employ different encryption techniques that can hinder or prohibit accurate longitudinal linking patient records. In particular, attention is paid to the design of matching algorithms that can be used to longitudinally link “de-identified” patient records. The desirable matching algorithms conform to industry standards for data format, to HIPAA privacy regulations and/or other private industry patient privacy safeguards or initiatives.

### SUMMARY OF THE INVENTION

The present invention provides matching algorithms and processes for linking de-identified patient transaction data records in a longitudinal database. The matching algorithms are designed to assign internal longitudinal identifiers or tags to the de-identified patient data records. The internal longitudinal identifiers do not reveal patient identity information, but can be used to longitudinally link the data records effectively in a statistically valid manner despite the lack of direct knowledge of patient identity. The internal longitudinal identifiers are assigned to incoming data records-by-matching encrypted data attribute values with those in reference data records, which may have been created from previously received non-matching records or other historical data.

The matching algorithms are designed to evaluate a select set of “matching” data attributes, one or all of which may be present in an incoming data record. The select set may include both encrypted data fields and non-encrypted data fields. The matching algorithms are also designed to sequentially compare different subsets of the matching attributes in an incoming data record with corresponding subsets in the reference data records.

In a preferred matching process, a matching rule is established to identify and prioritize different matching attribute subsets in a hierarchy of levels. An incoming data record is evaluated level-by-level. Upon successful matching of the data record attributes at any particular level, the incoming data record may be assigned the internal identifier associated with the reference data record. In the case where an incoming data record does not match any existing reference data record, the incoming data record may be assigned a newly generated internal identifier.

The reference data records may be assembled as a table or index of longitudinal identifiers and corresponding data attribute values. This table or index may be used-by-the matching algorithms to “triangulate” matches across multiple data suppliers and transaction types. The table or index may be updated as incoming data records are matched or new internal longitudinal identifiers are generated and assigned.

Further features of the invention, its nature and various advantages will be more apparent from the accompanying drawing and the following detailed description.

### BRIEF DESCRIPTION OF THE DRAWINGS

FIG. 1 illustrates a standardized set of data fields in data records that are evaluated using matching algorithms, in accordance with the principles of the present invention.

FIG. 2 illustrates an exemplary set matching rules for assignment of longitudinal linking identifiers to data records under different transaction data scenarios, in accordance with the principles of the present invention.

FIGS. 3a-3c are schematic process flow diagrams illustrating the exemplary steps of a process for matching data records attribute level-by-level and for assigning longitudinal linking identifiers to the data records, in accordance with the principles of the present invention.

FIG. 4 is an illustration of the logic of a software subroutine deployed for implementing the attribute level-by-level matching process of FIGS. 3a-3c, in accordance with the principles of the present invention.

FIG. 5, which is reproduced from U.S. patent application Ser. No. ______, is a block diagram of an exemplary system for assembling a longitudinal database from multi-sourced patient data records. The matching processes of FIGS. 1-4 may be implemented in the system, in accordance with the principles of the present invention.

### DESCRIPTION OF THE INVENTION

Matching algorithms are provided for assigning internal longitudinal linking identifiers or tags to de-identified patient transaction data records. Data records tagged with the assigned longitudinal linking identifiers may be readily linked identifier-by-identifier to assemble a longitudinal database without accessing personal information that can identify individual patients. Suitable matching algorithms (e.g., multi-level deterministic algorithms) may be used to determine if a new or previously defined ID should be assigned to a set of encrypted data attributes. Once a new or previously defined ID has been assigned, the ID may then be used to link back to tag full data records, which include detailed transaction information.

For assembly in the longitudinal database, patient transaction data records are first processed so that the data fields in the data records are in a standardized common format and then encrypted. The data records include at least one or more data fields corresponding to a select set of data attributes. The select set of data attributes may include transaction attributes which when not encrypted are patient identifying as well other transaction attributes which are not patient-identifying. The inventive matching algorithms evaluate the values of the encrypted attributes in the data record and accordingly assign an internal longitudinal linking identifier to the data record. The evaluation may involve iteration, reference comparison, probabilistic or other statistical techniques for assigning a suitable longitudinal linking identifier. The select set of data attributes, which are evaluated, is chosen with a view to reduce errors in assigning proper longitudinal linking identifier to the data records.

The inventive matching algorithms are described herein with reference to their application in the context of an illustrative solution, (which is described in co-invented and co-pending U.S. patent application Ser. No. ______, filed on even date, (Atty. Docket No. AP36247)), for integrating multi-sourced patient data records individual patient-by-patient into a longitudinal database without risking breach of patient privacy. U.S. patent application Ser. No. ______, is hereby incorporated by reference in its entirety herein. It will be understood that the specific solution is referenced for purposes of illustration only, and that the inventive matching algorithms may readily find application in other solutions for integrating de-identified data records in a longitudinal database.

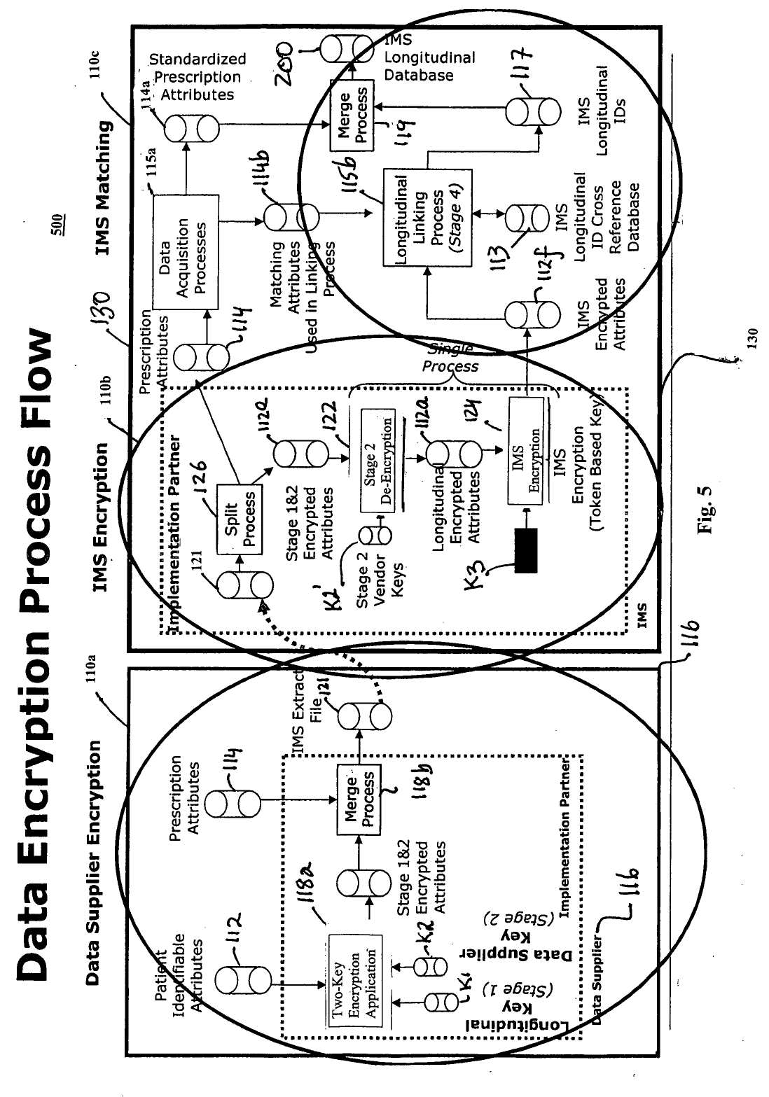

In order that the invention herein described can be fully understood, a brief description of the solution described in the referenced application is provided herein. FIG. 5, which is reproduced from the referenced application, shows system components and processes of an exemplary solution 500 for assembling a longitudinal database from multi-sourced patient data records. A two-step encryption procedure using multiple encryption keys is employed to de-identify patient data records. Solution 500 involves data sources or suppliers (“DS”), a longitudinal database facility (“LDF”), and a third party implementation partner (“IP”) and/or key administrator. At the first step, each DS encrypts selected data fields (e.g., patient-identifying attributes and/or other standard attribute data fields) in the patient records to convert the patient records into a first “anonymized” format. Each DS uses two keys (i.e., a vendor-specific key and a common longitudinal key associated with a specific LDF) to doubly encrypt the selected data fields. The doubly encrypted data records are transmitted to a facility component site, where they are processed further. The data records are processed into a second anonymized format, which is designed to allow the data records to be effectively linked individual patient-by-patient without recovering the original unencrypted patient identification information.

For this purpose, the doubly encrypted data fields in the patient records received from a DS are partially de-crypted using the specific vendor key (such that the doubly encrypted data fields still retain the common longitudinal key encryption). A third key (e.g., a token based key) may be used to further prepare the now-singly (common longitudinal key) encrypted data fields or attributes for use in a longitudinal database. Longitudinal identifiers (IDs) or dummy labels that are internal to the LDF may be used to tag the data records so that they can be matched and linked individual ID-by-ID in the longitudinal database without knowledge of original unencrypted patient identification information.

Suitable matching algorithms may be used to determine if a previously defined or new ID should be assigned to a set of encrypted data attributes. Once an ID has been determined, the ID is then linked back to the detailed transaction records from the data supplier using a set of agreed upon matching attributes that have been passed through the process along with the encrypted attributes. The encrypted data attributes and the assigned ID are then stored within a reference database for use in future matching processes.

According to the present invention, an ID may be assigned to the data record based on evaluation of a select set of attributes/data fields, one or more of which may be present in the data record. The selected set of data fields may include data fields that are designated to contain encrypted patient-identifying information and data fields that contain other transaction information. Matching rules are provided for evaluating data records incrementally attribute-by-attribute or by subsets of attributes. The evaluation involves comparison of the attribute/data field values with matching records in a reference database that includes an index of previously used IDs and corresponding data attribute/field values.

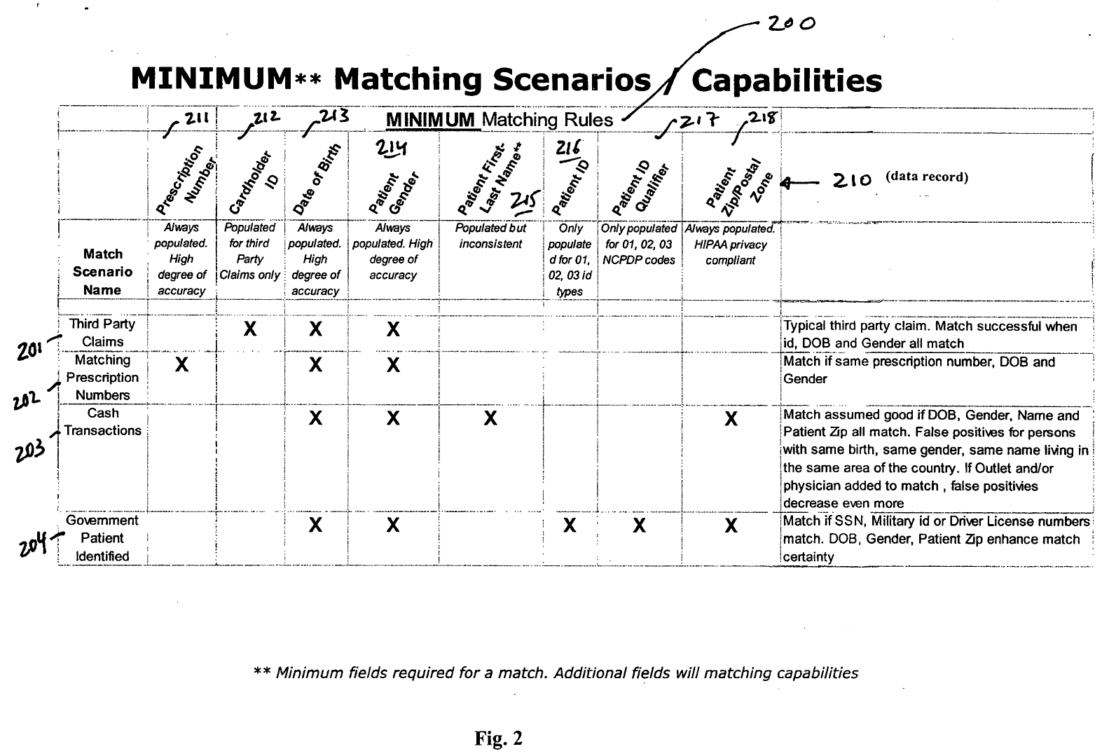

FIG. 2 shows an exemplary set of matching rules 200 that may be used for assignment of IDs to patient transaction data records under different transaction scenarios (e.g., scenarios 201-204). Matching rules 200 assign an ID to a data record (e.g., data record 210) based up on successful matching of the values of a variable subset of attributes/data fields in the data record with reference record values corresponding to the ID. Matching of attributes/data fields subset-by-subset is referred to herein as “level-by-level” matching.

Under matching rules 200, the number and type of attributes/data fields whose values are required to be successfully matched before the ID can be assigned to data record 210 may be varied according to the characteristics of data record 210. For example, under scenario 201 in which data record 210 represents a third party claim, a successful ID match may be declared when Cardholder ID, Date of Birth and Patient Gender have reference values corresponding to the ID. Such a match may be referred to as a level 1 match. Under scenario 202 in which data record 210 has a known Prescription Number, a successful ID match may be declared if additional attribute (e.g., Date of Birth and/or Patient Gender) values match reference values. Such a match may be referred to as a level 2 match. Under scenario 203 in which data record 210 represents a cash transaction, a successful ID match may be declared when Date of Birth, Patient Gender, Patient Name, and Postal Zip attributes have reference values. Such a match may be referred to as a level 3 match. A level 3 match may yield false positives, for example, for persons who co-incidentally may have the same name, date of birth and gender, and happen to live in the same Postal Zip Code area. The incidence of false positives may be reduced by additionally requiring matching of Outlet and/or Physician attribute values before assigning an ID to the data record. Similarly under scenario 204 in which data record 210 represents a government patient transaction, a successful ID match may be declared when a Social Security Number, Military ID or Driver's License Number attribute has a matching reference value (level 4 match). In this case, the incidence of false positives may be reduced by additionally requiring Date of Birth, Patient Gender, and/or Postal Zip attributes to have matching reference values before assigning an ID to the data record.

Matching rule 200 is described herein as having only four matching levels. It will, however, be understood that the matching rules may include any suitable number of matching levels, the maximum number of which is mathematically limited only by the number of different combinations of data attributes present in the data records processed.

In an embodiment of the invention, the data records that are supplied to a LDF are required to have data elements and data fields whose formats conform to a suitable industry standard, for example, the National Council for Prescription Drug Programs (NCPDP) standard. Under the standard, data suppliers may be required to include particular data fields and to use particular coding sets in preparing data records. Conformity to a standard format increases the likelihood that the patient transaction data records received at the LDF will have encrypted and non-encrypted data attributes that are suitable for application of the inventive matching algorithms. Such format conformity will also decrease the likelihood of matching errors that may otherwise occur due to varying data formats (e.g., due to severe variations in encryption output that can occur when even one character byte is off set or transposed in a data record).

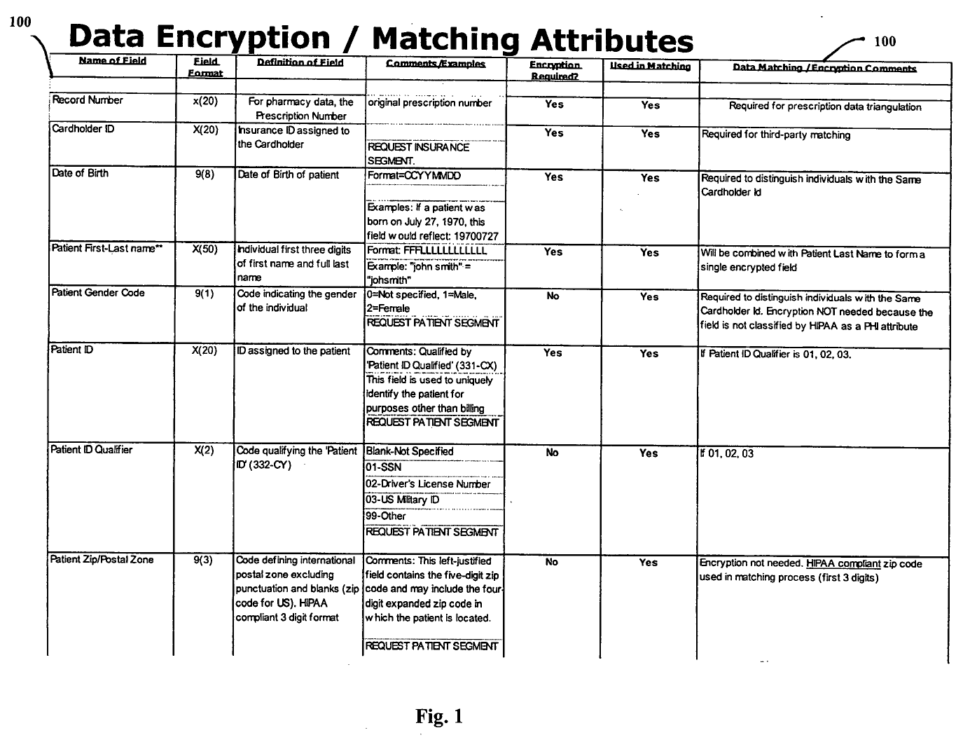

FIG. 1 shows an exemplary set 100 of selected data attributes/fields that a data supplier may include in patient transaction data records before release to the LDF. Exemplary set 100 includes data fields for eight named attributes (i.e. Record Number, Cardholder ID, Date of Birth, Patient's Last Name, Patient ID, Patient ID Qualifier, and Patient Postal Zip code). The data fields may have fixed formats (e.g., the data field corresponding to Record Number has 20 byte length). Several of these data fields in raw data records acquired or prepared by a data supplier may contain sensitive personal information (e.g., Record Number, CardHolder ID, Date of Birth, and Patient ID). These sensitive data fields are required to be encrypted by the data supplier prior to release of the data records to other parties such as the LDF. Further, to protect the privacy of individuals, the sensitive data fields may be required to be encrypted in a manner such that the personal information cannot be retrieved from the released data records under any circumstance. This encryption requirement makes longitudinal linking of the data records patient-by-patient impossible. Other data fields (e.g., Patient Gender, Patient Qualifier ID and Patient Zip/Postal zone) contain less sensitive information. These less sensitive data fields do not have to be encrypted at all times to avoid incurring risk of privacy breach. Both the encrypted and un-encrypted data fields in set 100 may be used for matching or assigning an ID to an encrypted patient transaction data record.

Set 100 is designed so that encrypted patient transaction data records can be longitudinally linked on a statistically valid basis without knowledge of or access to patient identifying information in the data records. Further, set 100 is designed to accommodate any variation in the attribute content of data records supplied by different data suppliers. For example, a data supplier may include only three patient-specific attributes (e.g., Gender, Date of Birth and Insurance ID Number attributes), but not include Patient Name and Patient Zip Code attributes in a patient transaction data record. Such a patient transaction data record may be assigned an ID “X” upon successful matching of the three patient-specific attributes included in the data record with corresponding data field values in a reference data record. A second data supplier may include all five patient-specific attributes (i.e., Gender, Date of Birth and Insurance ID Number, Patient Name and Patient Zip Code) in a patient transaction data record for the same individual patient. Such a patient transaction data record may be assigned the same ID “X” upon successful matching of the five patient-specific attributes in the reference data record associated with the same ID.

An incoming encrypted data record received at an LDF is tagged with an ID upon algorithmic evaluation of the contents of the data fields in set 100. The matching algorithms (e.g., matching rules 200) employed for this purpose may be designed to assign an ID to the data record based on level-by-level matching of the contents of the data fields.

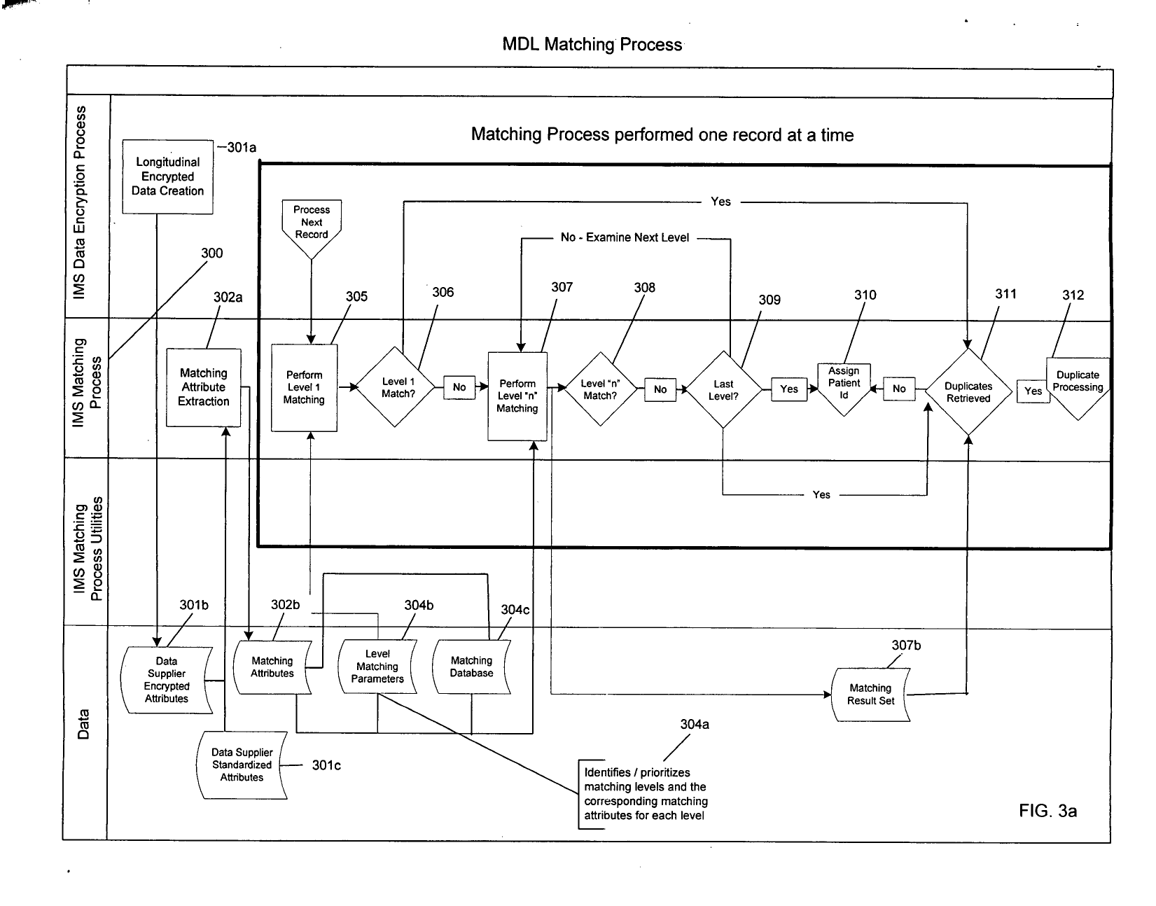

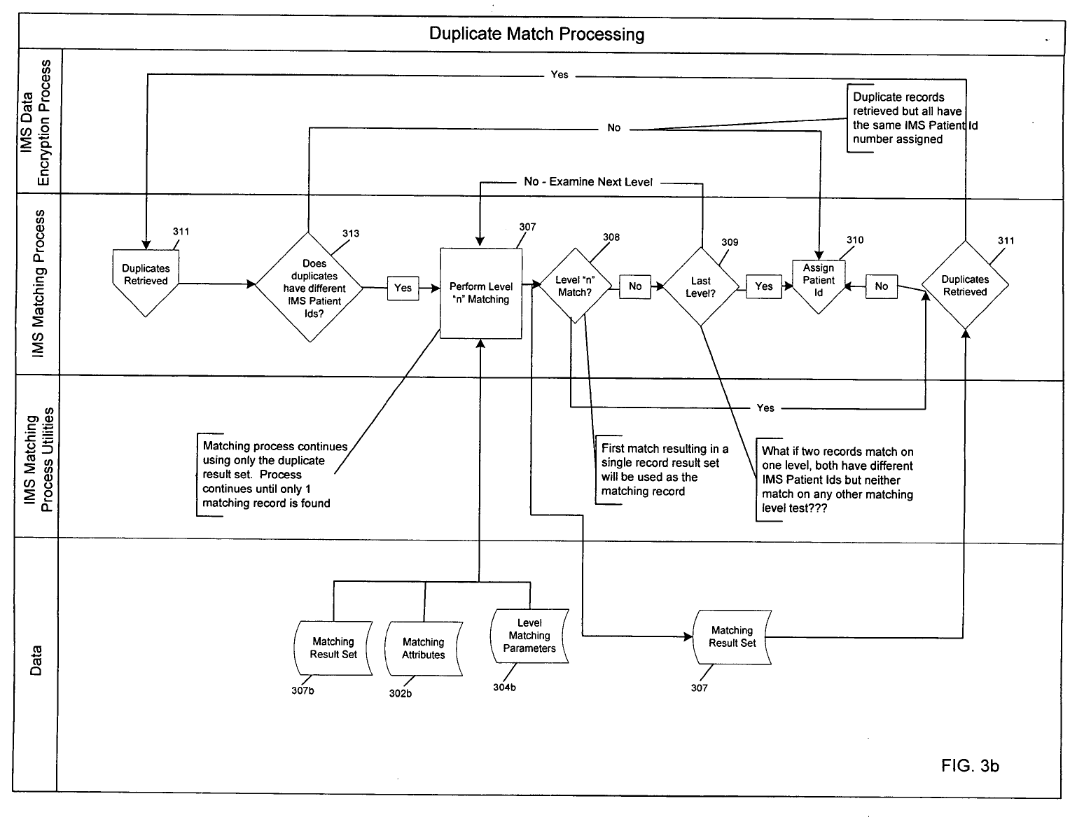

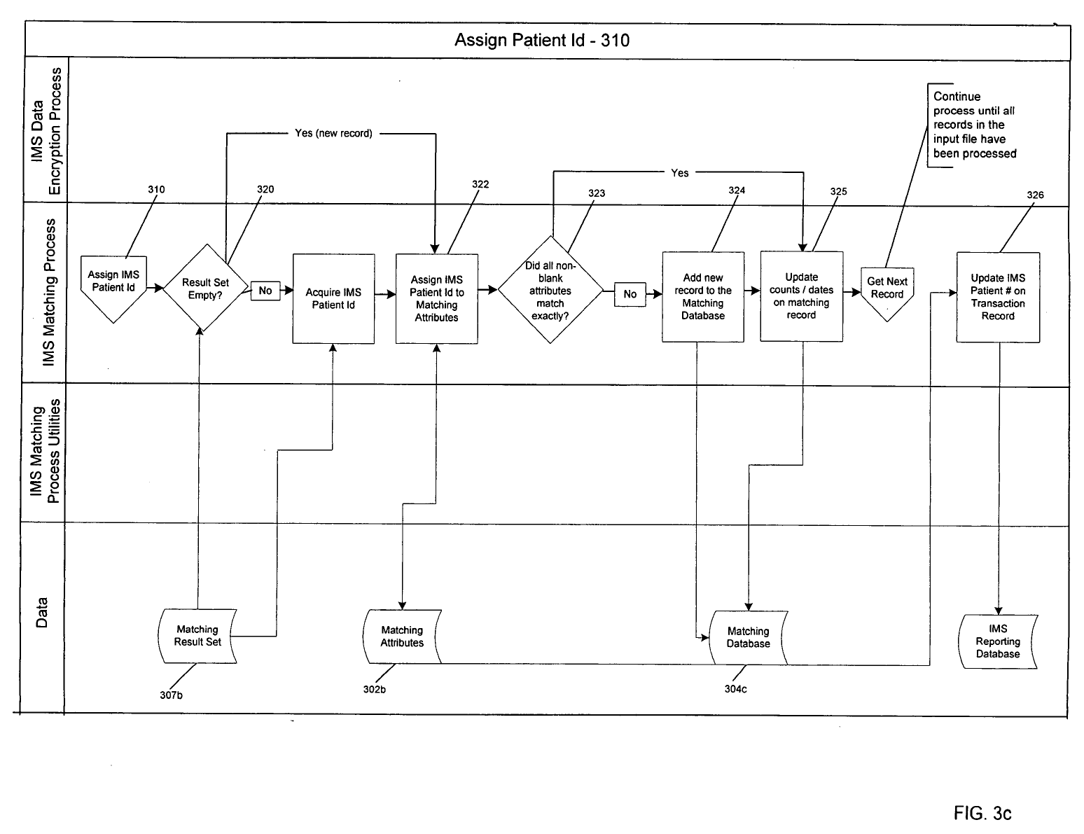

FIGS. 3a-3c show exemplary steps of a matching process 300 for assigning ID to a patient transaction data record. Matching process 300 may be implemented in the context of any suitable solution for assembling a longitudinal database (e.g. solution 500, FIG. 5). With reference to FIG. 3a, the patient transaction data record is first prepared for processing at a preparatory encryption step 301a. The prepared data record may include data supplier encrypted attributes 301b and other data supplier standardized attributes 301c. These attributes 301a and 301b, which may include some or all attributes from set 100 and additionally include other attributes. The specific attributes included may vary by data supplier or by transaction type.

At step 302a, a suitable set of “matching” attributes 302b is extracted from the data record. The set of matching attributes 302b is selected with consideration to the attribute/data field values evaluated by matching rule 200 (e.g., those corresponding to set 100). At step 304a, matching levels (e.g., scenarios 201-204) are identified and prioritized. Empirical priority algorithms may be established for this purpose. Further at step 304a, matching attributes 302b may be organized or arranged level-by-level in a set of level matching parameters 304b for convenience in further processing.

At step 305, the values of data attributes for the first designated level are compared with reference data records in a matching database 304c. The results of this comparison are evaluated at step 306. If the results are negative, at step 307 the values of data attributes for the next higher designated level “n” are compared with the reference data records. The results of this comparison are evaluated at step 308. If the results are negative, step 307 may be repeated to compare the values of data attributes for the next higher designated level “n+1” with reference records.

Before step 307 is repeated, at an intermediate step 309, a check is carried out to confirm that the current level number n does not exceed the highest number of designated levels N in matching rule 200. If all designated levels N have been processed without any successful match, at step 310 a new patient ID is generated and assigned to the data record.

If the result of either matching steps 305 or 307 is positive, then the matched data record and associated ID are included as a “successfully matched record” in a matching result set 307b. Matching result set 307b may include duplicates as more than one reference data record may be matched by any one level of data attribute subsets at steps 305 and 307. Matching result set 307b is processed further at step 312 so that only a single ID may be associated with the subject data record. For this propose, duplicate matched data attributes (“duplicates”) in matching result set 307b are retrieved at step 311. Next, at step 312 the duplicates are subject to a reduction process 314 by which multiple ID associations may be evaluated and removed. Process 314 is described herein with reference to FIG. 3b.

At step 313 in reduction process 314, the IDs associated with the duplicates are evaluated. If the duplicates are associated with the same ID, then at step 310, that ID is assigned to the subject data record. If the duplicates are associated with different IDs, step 307 through step 311 may be repeated to test whether additional attribute subsets or levels match the data record. Steps 307 through 311 may be repeated until a test result (step 308) is obtained by which matching result set 307 includes a single reference data record and associated ID. In the case that duplicate IDs persist, the subject data record may be dropped from consideration for inclusion in the longitudinal database. Conversely, when matching result set 307b is associated with a single ID, the subject data record may be considered for inclusion in the longitudinal database.

FIG. 3c shows details of step 310 by which an ID is assigned to a data record for inclusion in the longitudinal database. At step 320, matching result set 307 is evaluated. If matching result set 307 is empty, as may be the case when no level of data attributes in the subject data record have been successfully matched at steps 305 or 307, a new ID is assigned to the data record at step 322. Conversely, if matching result set 307 is not empty and includes a single reference record, the ID associated with the single f reference record is assigned to the set of matching attributes.

For audit or verification of new ID assignments and for updating the reference database 304c, a check is carried out at step 323 to see if all non-blank matching attributes in the data record were matched exactly. If all non-blank matching attributes were not matched exactly, then at step 324 the new ID and data record pair may be added to matching database 304c for future reference. If all non-blank matching attributes were matched exactly indicating that a previously used ID was assigned to the data record, it is not necessary to make a new ID entry in matching database 304c. In either case, at step 325 matching data base may be optionally updated with count and date information for each matched data record.

As a last step 326 in matching process 300, the patient data transaction record, which includes the subject data record, is tagged with the assigned ID so that the patient transition data records cam be easily linked in the longitudinal base.

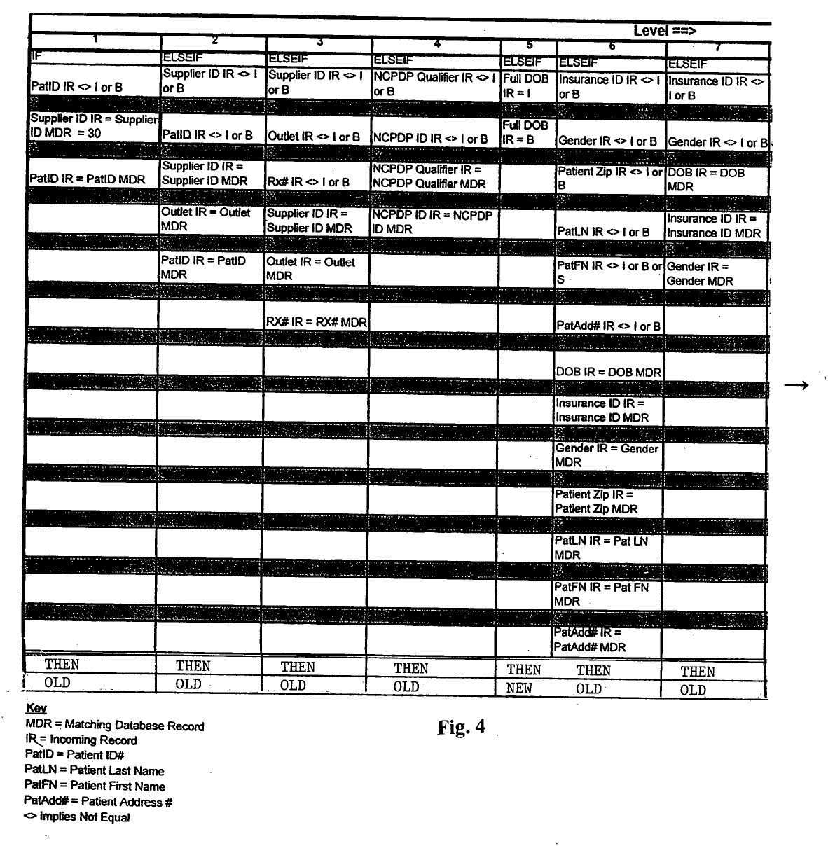

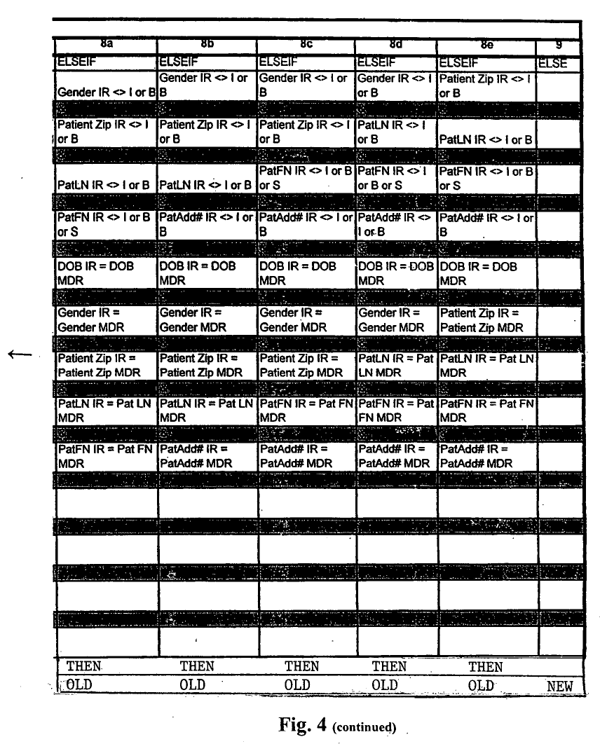

In accordance with the present invention, software (i.e., computer program instructions) for implementing the aforementioned matching algorithms and processes can be provided on computer-readable media. It will be appreciated that each of the steps (described above in accordance with this invention), and any combination of these steps, can be implemented by computer program instructions. Any suitable computer programming language may be used for this purpose. FIG. 4 shows an implementation of matching process 300 as a computer subroutine 400 for processing patient data records. In subroutine 400, matching rules 200 are applied to a select set of data attributes (e.g., data set 100) as a series of nested IF-ELSE IF-THEN conditional statements, each of which corresponds to a level of data attributes in the data records tested.

The computer program instructions can be loaded onto a computer or other programmable apparatus to produce a machine, such that the instructions, which execute on the computer or other programmable apparatus create means for implementing the functions of the aforementioned matching processes and algorithms. These computer program instructions can also be stored in a computer-readable memory that can direct a computer or other programmable apparatus to function in a particular manner, such that the instructions stored in the computer-readable memory produce an article of manufacture including instruction means which implement the functions of the aforementioned innervated stochastic controllers and systems. The computer program instructions can also be loaded onto a computer or other programmable apparatus to cause a series of operational steps to be performed on the computer or other programmable apparatus to produce a computer implemented process such that the instructions which execute on the computer or other programmable apparatus provide steps for implementing the functions of the aforementioned matching algorithms and processes. It will also be understood that the computer-readable media on which instructions for implementing the aforementioned the aforementioned matching algorithms and processes are provided, include without limitation, firmware, microcontrollers, microprocessors, integrated circuits, ASICS, and other available media.

It will be understood that the foregoing is only illustrative of the principles of the invention, and that various modifications can be made by those skilled in the art, without departing from the scope and spirit of the invention, which is limited only by the claims that follow. For example, select set 100 of data attributes used for matching has been described as having eight named data attributes (i.e. Record Number, Cardholder ID, Date of Birth, Patient's Last Name, Patient ID, Patient ID Qualifier, and Patient Postal Zip code) only for purposes of illustration. The select set may be readily modified to include fewer, more or alternate data attributes. Attributes/data fields whose contents encounter high volatility over time diminish in value when used in an encrypted format for longitudinal matching. Data fields whose contents are not volatile have greater value for longitudinal matching. Accordingly, the set of data fields in a transaction data record that are used for matching (or assigning IDs) preferably includes data fields whose contents are not volatile or less volatile (e.g., outlet or physician attributes). The inclusion of such data fields in the matching algorithms will likely reduce false positives.

Further, the number, type, sequence or order of matching levels may be adjusted or optimized by individual data supplier in response to supplier specific data characteristics. For example, if a data from a particular data supplier is associated with a higher level of confidence in the patient name information, matching levels using the patient name attribute may be moved up higher up in the sequence of matching levels. Conversely, if a particular data supplier does not provide one of the attributes used in the top levels of the matching process, the levels using that attribute may be moved to a lower level in the matching priority.

Another exemplary modification relates to the manner in which the reference data records (e.g., in matching database 304c) are updated. Matching database 304c includes data records corresponding to all unique combinations of matching attributes that have been previously noted in the matching processes. A new data record is added to the reference database if it does not match any of the existing reference data records. A new longitudinal tag may be associated with the un-matched data record attribute set, as described above, and both added to the reference database. Additionally or alternatively, existing data records in the reference database may be modified based on ongoing results in the matching process. Using the level-by level matching process, an incoming data record may be matched with an existing longitudinal tag, even when one of the attributes in the incoming data record is not in the set of attributes in the reference data record associated with the particular longitudinal tag. For example, an incoming data record may include six attributes A, B, C, D, E, and F. In one of the early matching levels, the data record may match on attributes A, B, and C to an existing longitudinal tag. However, attribute F (e.g., last name) may be different (e.g., due to a name change or variation) than that previously associated with the particular longitudinal tag. In such instances, the reference data record associated with the existing longitudinal tag may be updated to include the new or corrected combination of attributes. For example, the reference data base may be updated to associate a new reference data record with the particular longitudinal ID. The new data record includes matching attributes A, B, C, D, and E, which were previously associated with the particular longitudinal ID, and the new or corrected attribute F. Such updating of the database will allow the matching process to correctly associate the particular longitudinal tag, when the incoming data records have a last name variation, for example, due to different data supplier or customer usage (e.g., spelling).

1. A method for assigning longitudinal linking tags to de-identified patient data records, the method comprising the steps of:
(a) acquiring a de-identified patient data record, the data record having data fields corresponding to a positive number of data attributes from a designated set of data attributes;
(b) matching a subset of the data field values with a reference data record that is associated with a linking tag; and
(c) in response to a positive match at step (b), assigning the linking tag to the de-identified patient data record.

2. The method of claim 1 wherein the designated set of data attributes comprises encrypted data attributes.

3. The method of claim 2 wherein the encrypted data attributes comprise at least one of Record Number, CardHolder ID, Date of Birth, and Patient ID attributes

4. The method of claim 2 wherein the designated set of attributes further comprises non-encrypted data attributes.

5. The method of claim 1 wherein step (b) further comprises matching a plurality of subsets of the data fields with the reference data record that is associated with the linking tag.

6. The process of claim 5 wherein the plurality of subsets of data fields are organized in an hierarchy of levels, and wherein step (b) comprises level-by-level matching with the reference data record that is associated with the linking tag.

7. The method of claim 6, further comprising in response to a negative match at step (b), repeating steps (b) and (c) with another reference data record that is associated with another linking tag.

8. The method of claim 7 wherein the another reference data record is one of a plurality of reference data records stored in a reference database.

9. The method of claim 8 when all of the reference data records in the reference database are exhausted without a positive matching result, further comprising step (d) of generating a new linking tag and assigning the new linking tag to the data record.

10. The method of claim 9 further comprising updating the reference database with the new linking tag and matched data field values.

11. The method of claim 10, further comprising assembling a longitudinal database by longitudinally linking the data records by their assigned linking tags.

12. Computer readable media comprising instructions for performing the method of claim 1.

13. A matching algorithm for assigning longitudinal linking tags to de-identified patient data records incoming from multiple data suppliers, the matching algorithm comprising:
a definition of a designated set of data attributes at least some of which are included in the incoming de-identified patient data records by each of the multiple data suppliers;
a definition of a hierarchy of levels of subsets of the designated set of data attributes; and
the steps of:
(a) matching the incoming data records with reference data records that are associated with known longitudinal linking tags, wherein each matching comprises hierarchal level-by-level comparison of the data attribute subsets;
(b) assigning the longitudinal linking tags associated with successfully matched reference data records to the incoming data records; and
(c) when no reference data records are successfully matched to an incoming data record, generating and assigning new linking tag to the incoming data record.

14. The matching algorithm of claim 13, when an incoming data record is successfully matched at step (a) to a plurality of known reference data records at one level of matching, further comprising the step of:
(d) comparing the incoming data record and successfully matched reference data records at higher levels of the data attribute subsets, whereby the incoming data record may be matched with a single reference data record

15. Computer readable media comprising instructions for performing the algorithm of claim 13.
